(19) United States
(12) Patent Application Publication
(10) Pub. No.: US 2004/0238096 A1
(43) Pub. Date: Dec. 2, 2004

(54) Method of painting a fluorescent window advertisement

(76) Inventor: Michael Cooper, Galena, MO (US)

Correspondence Address: RICHARD C. HIMELHOCH , ESQ, WALLENSTEIN & WAGNER , L.T.D., 311 South Wacker 53rd Floor, Chicago, IL, 60606-6622, US

(21) Appl. No.: 10/449,177

(22) Filed: May 30, 2003

(51) Int. Cl. E04B 2/00; B32B 31/00

(52) U.S. Cl. 156/71; 156/145; 156/278; 156/280; 40/594

(57) ABSTRACT

A method of creating a fluorescent painted sign, advertisement or decorative article for application to a window or wall. The method comprises applying a fluorescent paint to a first side of a white substrate material. Following this step, the method comprises applying a black vinyl or ink outline to the fluorescent paint applied to the white substrate material. A protective coating is then applied to the fluorescent paint and vinyl or ink outline. An adhesive is applied to a first portion of a second side of the white substrate material. The substrate material is then installed on a window or wall.

### TECHNICAL FIELD

The present invention is generally related to a method for creating an article such as a sign, decorative painting or advertisement, and more particularly to a method for providing a fluorescent painting for installation on a wall or window.

### BACKGROUND OF THE INVENTION

In the practice of painting at multiple window locations for advertising or promotional purposes, an artist will need to drive to many locations. At each location the artist will unload painting equipment and supplies, including any or all of the following: paint, rollers, brushes, trays, scrapers, water spray bottles, paint thinner, ladders, scaffolding, rags or towels, patterns, photographs, drop cloths, masking tape and any other supplies necessary. The artist will then paint the window, clean up the area around the painting, load everything back in the truck, and proceed to the next location. There are several problems associated with this method. These include: (1) the artist's time is limited by weather conditions, driving, unloading, cleaning, and loading tools and supplies, (2) painting on location produces mess from unavoidable paint drops and spills, (3) reproduction from location to location is variable and is dependent on the artist's ability or supplies, and (4) removal of paintings from windows is difficult, messy, and possibly toxic depending on the chemicals used in removing the painting from the window. The present invention addresses these issues and allows more flexibility to both the artist and client.

Over the last twenty years, the sign industry has experienced a technological revolution, first with computers and plotters and more recently with full color digital printers. The introduction of full color digital printers has nearly eliminated the need for sign painters. However, in certain sign categories, sign painters and artists are still flourishing, most notably rough wall (concrete, stucco, textures, etc.) paintings and fluorescent window paintings. In fact, fluorescent window paintings for advertising purposes have grown in popularity, especially among fast food restaurants, convenience stores, drug stores, auto dealerships, and almost every category of retail outlet. Fluorescent window painters have thrived in spite of the digital print revolution simply because digital printers cannot create an image as bright or durable as a window painting. “Fluorescent” is not a color. Instead, it is a category of pigmentation that is far brighter than other categories of pigmentation. Fluorescent ink used in digital printers cannot match the brilliance or lifespan of fluorescent paint because of the density of pigmentation. Additionally, because of a more complex and dense chemical makeup of fluorescent pigmentation, printing with fluorescent ink has a far shorter life span than fluorescent paint. Paint is thicker and simply provides more pigmentation than ink, thereby ensuring a longer lifespan and the ongoing need for window painters.

As mentioned above, the problems of window painters primarily revolve around creating consistent images for mass production, driving time of highly skilled artisans, cleanliness of the painting and painting removal, and finally the cost of the window painting (due primarily to the labor time required). Another problem is the ability to produce window paintings on a dependable time schedule due to variable traffic conditions and inclement weather that can easily postpone and delay window paintings.

The current state of the art process for fluorescent window paintings involves the following steps, all taken at the point of display: (1) white paint is applied to the window pane in the shape of the final painting to provide an opaque background which increases the durability of the fluorescent paint; (2) fluorescent paint is applied over the white paint in whatever colors or blends of colors are desired as an end product; (3) black paint is used as an outline and for detail around and on the fluorescent paint to complete the painting; and (4) a clear coat or UV protective coat may or may not be used on top of the painting to protect it from the sun and weather.

This method lacks consistency from location to location, painter to painter, and from city to city. The quality of the undercoat, fluorescent paint, black paint, brushes, rollers, and sealers may differ from painter to painter as well as, most importantly, the skill of the painters if different painters are used for the same sign campaign across different locations. The result is that the end product cannot be created on a dependable time schedule with a consistent and quality product, especially where a chain store with many locations across the country is the end user. Consistency in quality, durability and timeliness simply cannot be achieved when many different painters in different cities with unequal skills and materials are employed.

The present method combines the most desirable features of printing and painting images to provide an end product that is more durable, consistent and cleaner than the current state of the art.

### SUMMARY OF THE INVENTION

The present invention is directed to an improved method of painting a fluorescent window advertisement wherein the painting is created in a controlled factory environment and later installed on location at the window. The method creates a more effective window painting at a lower cost than the current state of the art. The method solves the problems of (1) consistency in design and quality for paintings requiring duplication, (2) cleanliness in both the application and removal of window paintings and (3) high cost of artistic talent used in an inefficient manner.

The present invention is intended to improve on the traditional method of window painting for advertising, promotional or decorative purposes. One objective of this invention is the creation of a process in which a fluorescent window painting can be mass produced in a factory setting without the necessity of highly skilled artists driving around wasting their time at different store locations. In particular, this invention is a process that allows fluorescent window paintings to be produced with a higher quality and lower cost and can be shipped to the end user. The end product is easy to install and remove by unskilled workers, thereby reducing the need for expensive artistic talent.

In one embodiment of the invention, a method for providing a painted substrate for use as a sign, advertisement or decorative article comprises the steps of: applying a fluorescent paint to a first side of a substrate material; applying a black vinyl outline to the fluorescent paint applied to the substrate material; applying a protective coating to the fluorescent paint and black vinyl outline; and, applying an adhesive to a first portion of a second side of the substrate material opposed from the first side of the substrate material.

The applying a fluorescent paint to a first side of a substrate material may comprise priming the substrate with a vinyl or paint primer or other bonding agent prior to or in conjunction with the applying a fluorescent paint. The substrate material is preferably a white paint mask or a spray mask. Such masks normally are provided with an adhesive and paper backing already applied. That is, the step of applying an adhesive to a first portion of a second side of the substrate material may be performed by the manufacturer of the paint mask or spray mask.

The method further includes transporting the painted substrate to a location for use, and installing the painted substrate on a window or wall. This may be accomplished in part by providing a removable backing to the adhesive applied to the first portion of the second side of the substrate material; and, removing the removable backing prior to installation of the substrate material to the window.

The applying an adhesive to a first portion of a second side of the substrate material opposed from the first side of the substrate material step can comprise applying the adhesive to a corner portion of the substrate material. However, other areas can be utilized. Moreover, instead of just one location, the method can include applying an adhesive to a second portion of the second side of the substrate material.

The applying a protective coating to the fluorescent paint and black vinyl outline step can comprise applying a clear coat to the fluorescent paint and black vinyl or an ultra violet sealer.

In another embodiment of the invention, a method for providing a fluorescent painted sign, advertisement or decorative article for application to a window or wall comprising the steps of: applying a fluorescent paint to a first side of a white substrate material; applying a vinyl outline or an ink outline (preferably black) to the fluorescent paint applied to the white substrate material; applying a protective coating to the fluorescent paint and vinyl outline or ink outline; and, applying an adhesive to at least a first portion of a second side of the white substrate material. Again, the substrate material can be a paint mask or spray mask in which an adhesive and a removable paper backing has already been applied by the manufacturer.

The method further includes placing a removable backing against the adhesive applied to the first portion. The substrate material is utilized by transporting it to the location of use removing the backing placed against the adhesive applied to the first portion of the white substrate material; and, installing the white substrate material onto a window or wall. The installation comprises pressing the adhesive against the window or wall.

The applying the vinyl outline or ink outline to the fluorescent paint applied to the white substrate material step can comprise printing an ink outline to the fluorescent paint with a printing machine.

Utilizing this method, one can create a plurality of substantially identical fluorescent painted signs, advertisements, or decorative articles.

Again, a clear coat or ultra violet sealer can be applied to the fluorescent paint and the one of a vinyl outline and an ink outline.

In yet another embodiment of the invention, a method for creating a fluorescent painted sign, advertisement or decorative article for placement on a window comprises the steps of: applying a fluorescent paint to a first side of a white paint mask material; applying a black vinyl outline to the fluorescent paint in a pattern; applying a protective coating to the fluorescent paint and black vinyl outline; applying an adhesive to a first portion of a second side of the white paint mask material; placing a removable backing to the adhesive applied to the first portion of the white paint mask material; and, removing the removable backing and installing the white paint mask material to a window or wall. The pattern can be any decorative design, words or combination thereof.

The present invention relates to techniques for painting fluorescent paintings, especially on windows, but also applies to banners, metal, wood, plexi-glass and other smooth substrates. The present method has applications for advertisements as well as holiday and decorative temporary paintings. Moreover, the present invention: (1) eliminates needs of the artist to paint at store locations; (2) allows consistent and quality duplication; (3) allows easy installation and removal from windows; (4) eliminates paint mess at location of window by painting method and removal; and, (5) provides a neater appearance from inside the window.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a front plan view of a fluorescent painted panel in accordance with an embodiment of the present invention;

FIG. 2 is a front plan view of a paint mask or other substrate panel for use as part of the fluorescent painted panel;

FIG. 3 is a front plan view of the paint mask or other substrate panel of FIG. 2 painted with a solid fluorescent paint;

FIG. 4 is a cross-sectional view of a fluorescent painted panel having a paper backing;

FIG. 5 is a cross-sectional view of a fluorescent painted panel applied to a window;

FIG. 6 is a front plan view of one embodiment for installation of a fluorescent painted panel on a window;

FIG. 7 is a front plan view of another embodiment for installation of a fluorescent painted panel on a window;

FIG. 8 is front plan view of a fluorescent painted panel partial removed from a window surface;

FIGS. 9A-9B show installation of a fluorescent painted panel onto a window surface.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

The present method is preferably utilized to create an article such as a sign, decorative painting or advertisement. Referring to FIG. 1, a fluorescent painted substrate or panel 10 is shown in the form of an advertisement for a sale. The painted substrate 10 includes a layer of a fluorescent paint 12. A vinyl or ink is printed on the fluorescent paint to form an outline or pattern 14. In this case, the vinyl or ink outline forms the word “SALE.”

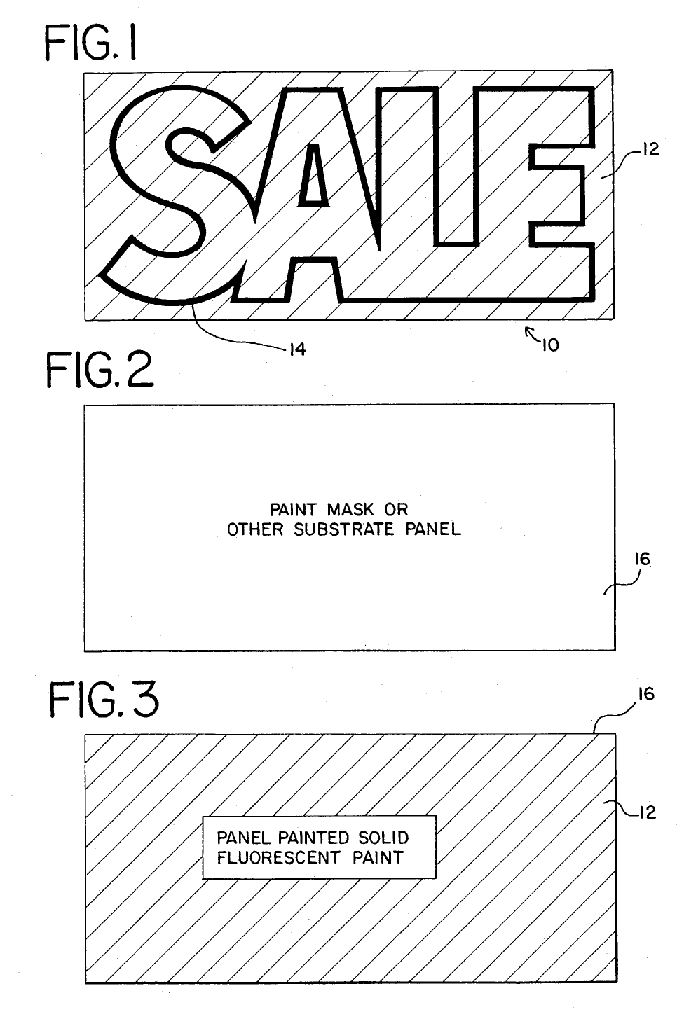

To create the article or painted substrate 10, a substrate material 16 is painted with the fluorescent paint 12. FIG. 2 shows a substrate material 16 before being painted. FIG. 3 shows the substrate material 16 after receiving a layer of fluorescent paint 12. Preferably, in forming the painted substrate 10, fluorescent paint is applied in one or more colors, or blends of colors, to a white substrate material 16 that is receptive to the paint. The preferred material for this invention is a paint mask or spray mask. Such materials are used for stencils in the sign industry but not as a substrate for signs or paintings. This step eliminates the need for a white undercoat of paint since the substrate is already white and opaque.

After painting the white substrate material 16 with the fluorescent paint 12, black vinyl or ink 14 is then applied to or printed on the fluorescent painted panel 16 as an outline and for detail in the same manner that black paint is used to outline a fluorescent window painting. This step utilizes modern signmaking technology to provide an end product that is perfect in its consistency, as contrasted with normal window paintings. It is important to note that the step requiring the greatest artistic skill in a window painting is the black painted outline and detail. This step separates good painters from poor and inexperienced painters, and is the step that determines the quality and consistency in the final outcome. This is the finishing step and can only be performed by highly skilled artists. By substituting vinyl or ink for this outlining step, the process is simplified to a manufacturing process instead of an artistic process. Painting solid or blended fluorescent paint on a panel can be performed by anyone with a little training. Painting the black outline and detail in a satisfactory way requires years of practice and even then, inconsistencies in the product inevitably arise from location to location, and from city to city in large advertising campaigns. Allowing the artist to create a large number of identical signs at one location will provide a more consistent sign.

After the black vinyl or ink 14 is applied, a clearcoat or UV (ultra violet) sealer 18 is then applied to the painted substrate 16. The clearcoat or UV sealer 18 gives the painted substrate 16 a longer life and protection from the sun, weather, or window washer. The clearcoat or UV sealer 18 also seals the vinyl to the paint surface giving the end product necessary durability for transport and installation.

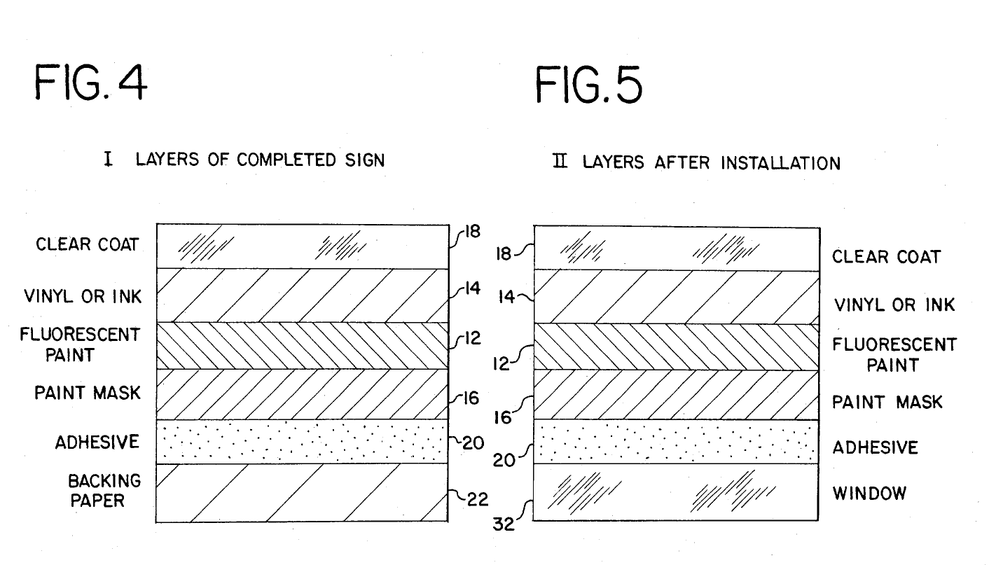

An adhesive 20 is applied to at least a portion of substrate material 16 on the side opposite the side with the fluorescent paint. A paper backing 22 (or other suitable backing material) is secured to the substrate material 16 over the adhesive 20 to facilitate transportation of the painted substrate 16. All the various layers of the finished article 10 are shown in FIG. 4. If a paint mask or spray mask is utilized, application of the adhesive 20 may have been done by the manufacturer of the paint mask or spray mask.

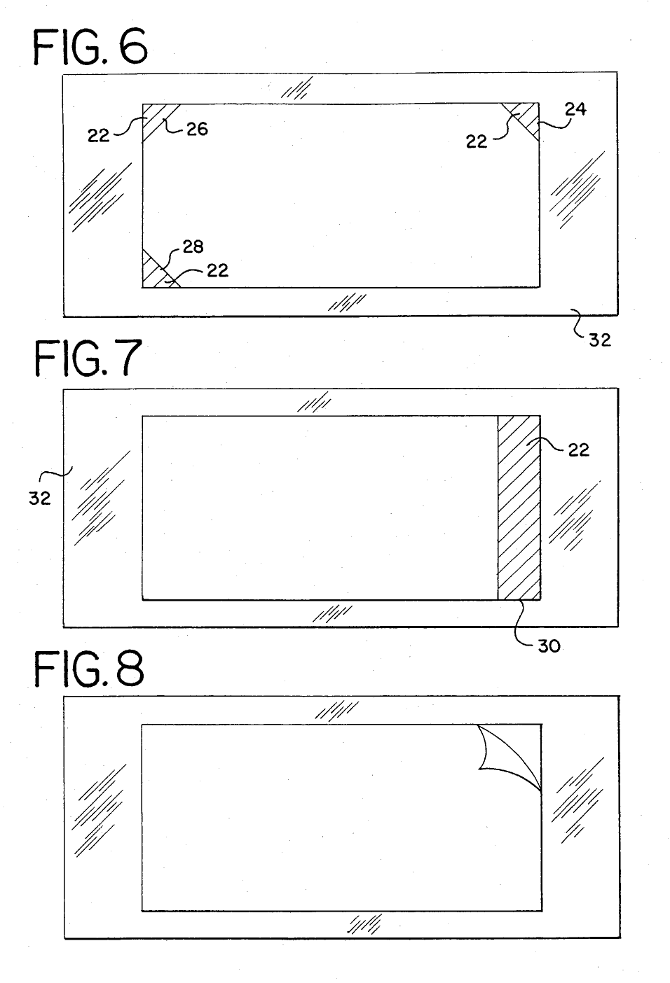

The adhesive 20 can be a continuous layer on the backside of the substrate material 16, or it may be placed at strategic locations. For example, as shown in FIG. 6, the adhesive 22 is placed at a first location in one corner 24, at a second location in a second corner 26, and at a third location in a third corner 28. The adhesive may also be placed in the last corner. In an alternative embodiment shown in FIG. 7, the adhesive 22 is placed along one side 30 and can act as a hinge.

The final step is the installation of the end product 10 at the client's location in a simple peel and stick procedure (if paint mask is used). Paint mask is a material that has never previously been used as a substrate for window paintings. According to one leading manufacturer, Graphic Materials International, paint mask “products are used for masking surfaces to be painted and for die-cut/hand-cut spray mask stencils.” (www.gmintl.com) Because of its texture and adhesive qualities, it is perfectly suited for this process. The paint mask readily accepts paint and has a tackiness that is easy to install and easy to remove when the painting has run its course. When the advertising campaign is over, the window painting can simply be pulled off the window in a mess free operation, eliminating the need for aggressive window cleaning techniques such as scraping or paint removing chemicals. Anyone can remove these window paintings easily, and consequently, the client need not hire a window cleaner to remove the window painting. Notably, this invention creates an environmentally superior, toxic free end product in that it eliminates paint spills and the use of cleaning chemicals at the final installation location.

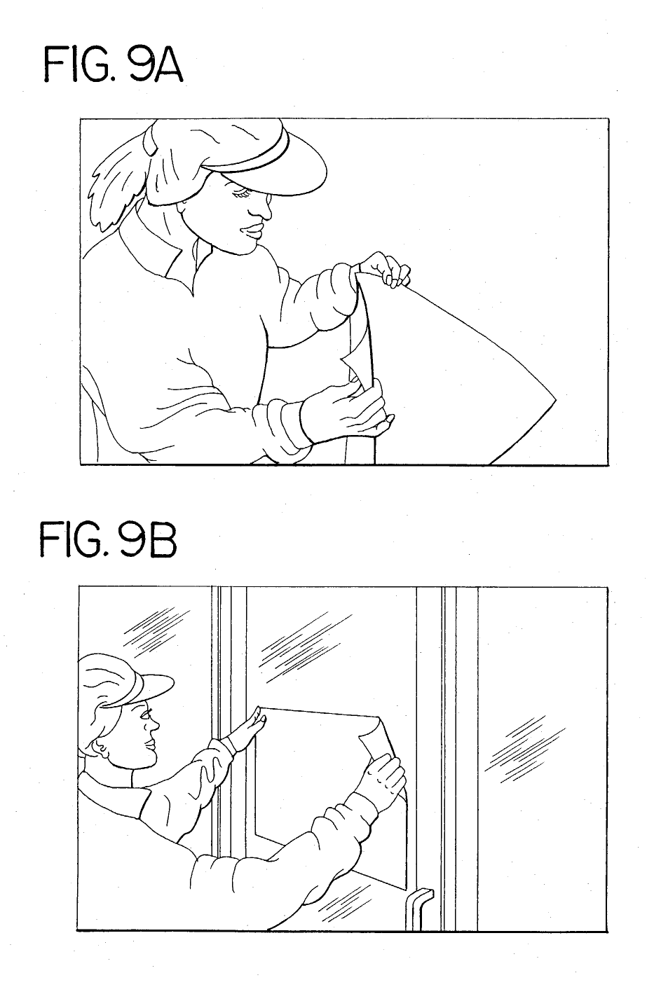

The article 10 is transported to the location for installation. The backing 22 is removed and the adhesive layer 22 is pressed against a window 32, wall or other suitable structure to which the article 10 can be applied, as shown in FIGS. 9A-9B. FIG. 5 shows the various layers of the article 10 when installed on a window. After its use is completed, the article can be peeled from the window as shown in FIG. 8.

Of course, this process begs the question, “Why not print the whole sign using a digital printer with fluorescent ink and sidestep paint altogether?”The answer, as alluded to, is that fluorescent ink does not have the pigmentation and consequently, the durability and lifespan of fluorescent paint.

In summary, this invention joins an old process of painting with a modern technique of sign making to create a process which heretofore, has never been used. The result is a long lasting, brilliant, consistent, clean, and cost-effective form of painting previously unavailable in the market.

It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

I claim:

1. A method for providing a painted substrate for use as a sign, advertisement or decorative article comprising the steps of:
applying a fluorescent paint to a first side of a substrate material;
applying a black vinyl outline to the fluorescent paint applied to the substrate material;
applying a protective coating to the fluorescent paint and black vinyl outline; and,
applying an adhesive to a first portion of a second side of the substrate material opposed from the first side of the substrate material.

2. The method of claim 1 wherein the applying an adhesive to a first portion of a second side of the substrate material opposed from the first side of the substrate material step comprises applying the adhesive to a corner portion of the substrate material.

3. The method of claim 2 further comprising the step of:
installing the substrate material onto a window.

4. The method of claim 2 further comprising the step of:
applying an adhesive to a second portion of the second side of the substrate material.

5. The method of claim 1 wherein the substrate material is a paint mask.

6. The method of claim 1 wherein the substrate material is a spray mask.

7. The method of claim 1 wherein the substrate material is white prior to application of the fluorescent paint.

8. The method of claim 2 further comprising the step of:
providing a removable backing to the adhesive applied to the first portion of the second side of the substrate material; and,
removing the removable backing prior to installation of the substrate material to the window.

9. The method of claim 1 wherein applying a protective coating to the fluorescent paint and black vinyl outline comprises applying a clear coat to the fluorescent paint and black vinyl.

10. The method of claim 1 wherein applying a protective coating to the fluorescent paint and black vinyl outline comprises applying an ultra violet sealer to the fluorescent paint and black vinyl.

11. A method for providing a fluorescent painted sign, advertisement or decorative article for application to a window or wall comprising the steps of:
applying a fluorescent paint to a first side of a white substrate material;
applying one of a vinyl outline and an ink outline to the fluorescent paint applied to the white substrate material;
applying a protective coating to the fluorescent paint and the one of a vinyl outline and an ink outline; and,
applying an adhesive to a first portion of a second side of the white substrate material.

12. The method of claim 11 wherein the applying an adhesive to a first portion of a second side of the white substrate step comprises applying the adhesive to a corner portion of the white substrate material.

13. The method of claim 12 further comprising the step of:
applying an adhesive to a second portion of the second side of the white substrate.

14. The method of claim 12 further comprising the step of:
placing a removable backing against the adhesive applied to the first portion.

15. The method of claim 11 further comprising the step of:
removing the backing placed against the adhesive applied to the first portion of the white substrate material; and, installing the white substrate material onto a window.

16. The method of claim 11 wherein the substrate material is a paint mask.

17. The method of claim 11 wherein the substrate material is a spray mask.

18. The method of claim 11 wherein the applying one of a vinyl outline and an ink outline to the fluorescent paint applied to the white substrate material step comprises printing an ink outline to the fluorescent paint with a printing machine.

19. The method of claim 11 further comprising the step of:
creating a plurality of substantially identical fluorescent painted signs.

20. The method of claim 11 further comprising the step of:
creating a plurality of substantially identical advertisements.

21. The method of claim 11 further comprising the step of:
creating a plurality of substantially identical decorative articles.

22. The method of claim 11 wherein applying a protective coating to the fluorescent paint and the one of a vinyl outline and an ink outline comprises applying a clear coat to the fluorescent paint and the one of a vinyl outline and an ink outline.

23. The method of claim 11 wherein applying a protective coating to the fluorescent paint and the one of a vinyl outline and an ink outline comprises applying an ultra violet sealer to the fluorescent paint and the one of a vinyl outline and an ink outline.

24. A method for creating a fluorescent painted sign, advertisement or decorative article for placement on a window comprising the steps of:
applying a fluorescent paint to a first side of a white paint mask material having an adhesive applied to a first portion of a second side of the paint mask material and a removable backing covering the adhesive;
applying a black vinyl outline to the fluorescent paint in a pattern;
applying a protective coating to the fluorescent paint and black vinyl outline; and,
removing the removable backing and installing the white paint mask material to a window.

25. The method of claim 24 wherein applying a protective coating to the fluorescent paint and black vinyl outline comprises applying a clear coat to the fluorescent paint and black vinyl.

26. The method of claim 24 wherein applying a protective coating to the fluorescent paint and black vinyl outline comprises applying an ultra violet sealer to the fluorescent paint and black vinyl.
